(19) United States
(12) Patent Application Publication
(10) Pub. No.: US 2017/0308154 A1
(43) Pub. Date: Oct. 26, 2017

(54) FAST SYSTEM SETTING CHANGES

(71) Applicant: Lenovo (Singapore) Pte. Ltd., Singapore (SG)

(72) Inventors: Bryan Loyd Young, Tualatin, OR (US); Marc Richard Pamley, Durham, NC (US); William Fred Keown, JR., Raleigh, NC (US); John Scott Crowe, Durham, NC (US); Amy Leigh Rose, Chapel Hill, NC (US); Jennifer Lee-Baron, Morrisville, NC (US); Nathan J. Peterson, Oxford, NC (US); Gary David Cudak, Wake Forest, NC (US)

(21) Appl. No.: 15/137,660

(22) Filed: Apr. 25, 2016

(51) Int. Cl. G06F 1/32; G06F 9/445; G06F 9/44

(52) U.S. Cl. CPC G06F 1/3296; G06F 9/4403; G06F 9/44505

(57) ABSTRACT

One embodiment provides a method, including: receiving a command to modify a setting of a computer system, wherein the modification requires a power cycle to a processor; modifying, using a processor, the setting of the computer system based on the command; thereafter, placing the computer system in a sleeping state, wherein the sleep state removes power from the processor; and automatically waking up the computer system based on a wake up timer. Other aspects are described and claimed.

### BACKGROUND

With advancements in computer technology, various features and capability of computer systems have improved. For example, the introduction of the multicore processor. A multicore system allows for hyper-threading, which increases the parallelization of a computer system greatly. Although there may only be a single physical processor present in a computer system, the computer system's Operating System (OS) can address multiple virtual or logical cores to the processor and share the processing workload between them. This allows for an increase in the number of independent instructions a processor can manage, and takes advantage of superscalar architecture.

In this example however, it might not be beneficial to divide the processing power via the virtual or logical cores for certain functions or applications (e.g., those that require a large cache). Moreover, system level changes (e.g., changing processor settings, such as enabling or disabling hyper-threading, changes to memory settings, changes to power on settings, enabling or disabling non-uniform memory access (NUMA), etc.) typically affect the hardware of a computer system in such a way that a reboot or power cycle is required for them to take effect. Thus, if a user desires to switch between applications that may benefit from a change in the system settings the user is required to save their work, close all their applications, and reboot their system.

### BRIEF SUMMARY

In summary, one aspect provides a method, comprising: receiving a command to modify a setting of a computer system, wherein the modification requires a power cycle to a processor; modifying, using a processor, the setting of the computer system based on the command; thereafter, placing the computer system in a sleeping state, wherein the sleep state removes power from the processor; and automatically waking up the computer system based on a wake up timer.

Another aspect provides an information handling device, comprising: a processor; a memory device that stores instructions executable by the processor to: receive a command to modify a setting of a computer system, wherein the modification requires a power cycle to a processor; modify, using the processor, the setting of the computer system based on the command; thereafter, place the computer system in a sleeping state, wherein the sleep state removes power from the processor; and automatically wake up the computer system based on a wake up timer.

A further aspect provides a product, comprising: a storage device having code stored therewith, the code being executable by a processor and comprising: code that receives a command to modify a setting of a computer system, wherein the modification requires a power cycle to a processor; code that modifies, using the processor, the setting of the computer system based on the command; code that thereafter, places the computer system in a sleeping state, wherein the sleep state removes power from the processor; and code that automatically wakes up the computer system based on a wake up timer.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of fast system settings changes.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As computers have become more specialized in nature, so to have their capabilities. Thus, some tools or methods that that increase a computer's performance in one way may be less beneficial in a different particular circumstance or environment. It would therefore be beneficial for these advanced computer systems to have the capability to toggle on and off features based on the current task or application. The ability to toggle on and off certain hardware functions gives a user the ability to customize a computer system to best meet their current needs.

By way of example, hyper-threading technology may be used to improve parallelization of computations in some applications. However, other applications may not utilize parallelization to a high degree, thus leading to wasted power and potentially lower clock speeds. This reduction in efficiency may be avoided however by, for example, disabling the hyper-threading of the processor using, for example, the basic input/output system (BIOS). Unfortunately, making changes to the BIOS settings introduces further complications.

Typically, when making changes to a computer's BIOS settings a system reboot is required. Continuing from the above example of modifying the hyper-threading capability, a reboot is required to allow the processor to reset and pull the configuration from the newly modify BIOS. The requiring of a reboot means a user must end all their current tasks being worked on, reboot their computer system, and restart all of their tasks and/or applications. Although the number of applications that benefit from system level changes, like those discussed herein, may be low, the benefit they receive is great. Due to the nature of those applications, the performance and efficiency gains can make a large impact in the resources required (e.g., man hours, power demand, etc.) to operate the application.

For example, a particular application may be hampered when hyper-threading is enabled. This may be due to the fact that the processor cache is forced to be split between the primary and logical cores that are created when hyper-threading is enabled, as discussed herein. Because the processor cache size is reduced for each process, an application may have to reach out to (i.e., utilize) main memory more frequently to complete operations. This additional step can result in several additional clock cycles being used per operation than necessary if the full cache was available.

Currently, the only way to make the system changes (e.g., changes to the BIOS) is to shut down and reboot the entire system. As a result of this process, a user is required to stop their current task, save their work, and wait a lengthy reboot process. Even after the reboot process is complete, a user is required to restart each previously active application and reload their saved data prior to resuming their task. This technical issue presents problems for users that may utilize various applications that would benefit (e.g., increased efficiency, increased capability, etc.) from a system settings change. Thus, a solution that allows a user to conveniently and quickly adjust the system settings without requiring a total system restart is needed.

Accordingly, an embodiment provides a method of receiving a command to modify a setting of a computer system, wherein the modification requires a power cycle to a processor (e.g., a BIOS setting change). An embodiment then modifies the setting of the computer system (e.g., utilizing the operating system) based on the received command. Once the setting is updated, an embodiment places the computer system in a sleep state (e.g., S3, S4, etc.), which removes power from the processor, but allows other hardware components (e.g., hard drive, memory, etc.) to remain powered. Once power has been removed from the processor, a wake up timer may initiate the process of waking up the computer system including, among other things, restoring power to the processor. Because the computer was not required to perform a full reboot, the total downtime is greatly reduced. The user does not have to wait for the computer to boot up, restart all of the applications, and reload data because the data was recorded in a saved state prior to the computer being placed in the sleep mode.

The illustrated example embodiments will be best understood by reference to the figures. The following description is intended only by way of example, and simply illustrates certain example embodiments.

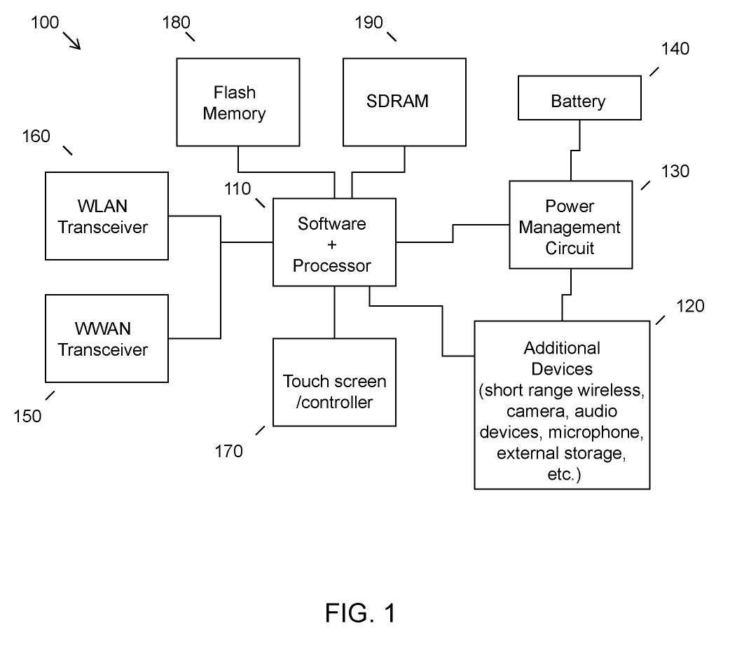

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and SDRAM 190.

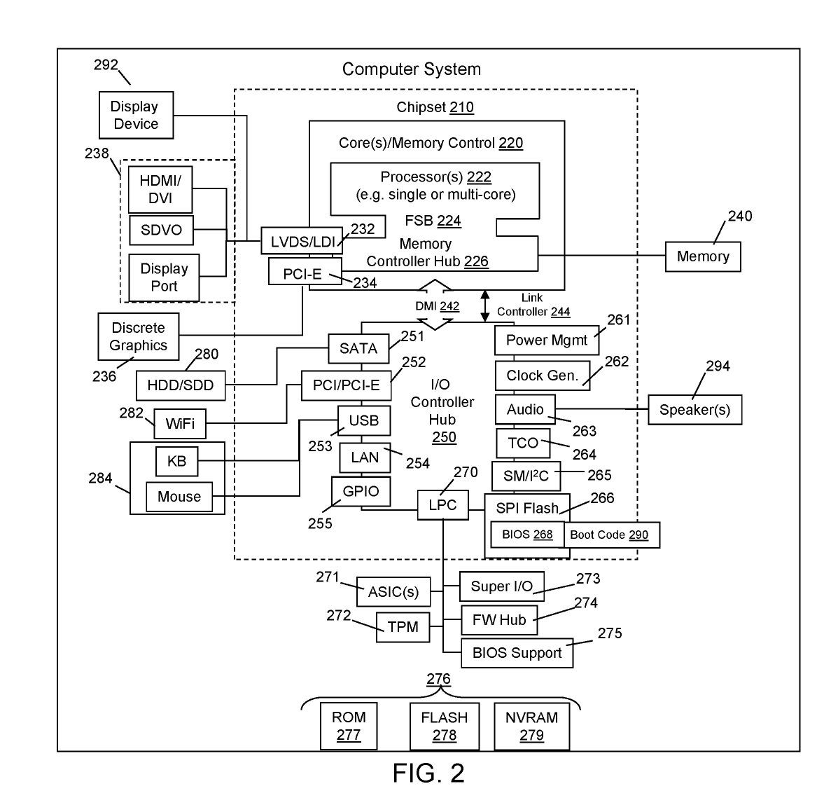

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which users may use for various applications that benefit from various settings (e.g., BIOS settings). For example, the circuitry outlined in FIG. 1 may be implemented in a tablet or smart phone embodiment, whereas the circuitry outlined in FIG. 2 may be implemented in a personal computer embodiment.

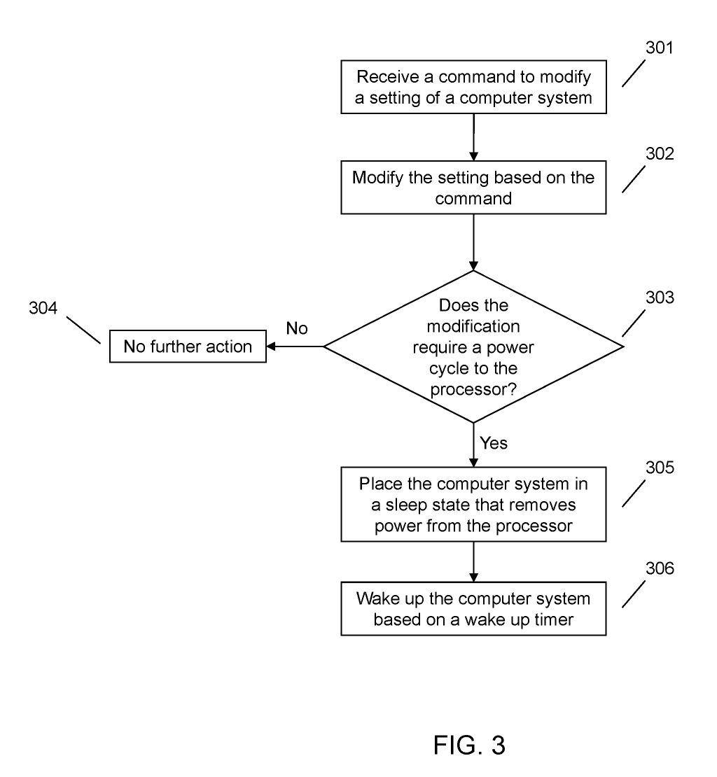

Referring now to FIG. 3, an embodiment may receive a command to modify a setting of a computer system (e.g., a firmware setting) at 301. The received command may be received via any available input, such as for example, a keyboard, mouse, track pad, voice command, gesture control, and the like. The computer system may then modify the system setting based on the received command at 302. In one embodiment, the settings changes may be made via the computer system's Advanced Configuration and Power Interface (ACPI). Generally, ACPI exports the available functionalities by providing certain instruction lists as part of the system firmware, which the operating system kernel interprets and executes to perform desired operations, using a form of embedded virtual machine. Additionally or alternatively, an embodiment may utilize Windows Management Instrumentation (WMI) calls to modify the system settings.

However, in many cases, especially when modifying firmware settings (e.g., BIOS, Unified Extensible Firmware Interface (UEFI), Open Firmware, ARCS firmware bootloader, etc.) the changes cannot go into effect until the processor has had its power cycled. For example, if a user wishes to enable or disable hyper-threading of a processor a power cycle is required to reconfigure such fundamental settings associated with the processor. A user may wish to alter these settings because some applications may benefit from the user of hyper-threading, while other applications may experience reduced efficiency and/or operation.

Accordingly, an embodiment determines the requested modification (301) requires a power cycle to the processor at 303. In one embodiment, the setting may be implemented without a power cycle. Thus, the modification to the system setting at 302 goes into effect and no further action is required to be taken at 304. Alternatively, if the modification does require a power cycle to the processor, an embodiment may place the computer system in a sleep state at 305. By way of example, an embodiment may make the received settings changes (301) and place the system in a sleep state (such as those described herein) via ACPI/WMI calls.

In a typical computer system, various levels of power states exist, such as S1, S2, S3, S4, S5, etc. For example, system power state S1 is typically a sleeping state with the following characteristics: reduced power consumption, processor clock being powered off, and bus clocks being stopped. This allows for quick software resumption, typically no longer than two seconds, with the entire hardware system context being maintained by the hardware. System power state S2 generally has similar characteristics with the addition that the processor context and contents of the system cache are lost because the processor loses power. Thus, after wake-up, control starts from the processor's reset vector.

System power state S3 is also a sleeping state which uses less power than S2, wherein the processor is off and some chips on the motherboard may also be powered down. Typically in power state S3, only system memory is retained, processor context, cache contents, and chipset context are all lost. System power state S4, is generally referred to as hibernation state. S4 is typically the lowest-powered sleeping state and thus has the longest wake-up latency. In order to attain the lowest power state, S4 typically has the power off to all hardware devices. However, operating system context is maintained in a hibernate file (an image of memory) that the system writes to disk before entering the S4 state. Upon restart, a loader reads this file and jumps to the system's previous pre-hibernation location. A computer in a hibernate state will generally use no power (with the possible exception of trickle current).

Thus, as discussed herein, states S1, S2, S3, and S4 are all sleeping states. A system in one of these states is not performing any computational tasks and appears to be off. Unlike a system in the shutdown state (S5), however, a sleeping system retains memory state, either in the hardware or on disk. The operating system need not be rebooted to return the computer to the working state.

With each successive sleep state, from S1 to S4, more of the computer system's hardware is shut down. All ACPI compliant computers shut off their processor clocks at S1 and lose system hardware context at S4 (unless a hibernate file is written before shutdown). Although the general concepts of the sleep states are standardized, details of the intermediate sleep states can vary depending on how a manufacturer has designed a specific machine. For example, on some machines certain chips on the motherboard might lose power at S3, while on others systems such chips retain power until S4.

Thus, an embodiment may, as discussed herein, place the computer system in a sleep state that removes power from the processor (e.g., S2, S3, and S4) at 305. A further embodiment may wake up and restart the system depending on hardware switching functionality at 306. This process (i.e., 301-306) allows an embodiment to remove power from a processor and resume to an operational state faster than a reboot, as many of the initialization states are normally unnecessary. Thus, an embodiment provides an advantage in that a user is able to change a system setting, reset one or more hardware components (e.g., the processor) and continue work without any changes to their current work environment (e.g., saving their work and closing applications to restart). In order to carry out the actions discussed herein, an embodiment may require that the computer system (e.g., operating system) be capable of hot plugging (hot swapping) components.

Accordingly, as illustrated by the example embodiments and figures, an embodiment provides placing a computer system in a hibernate (S4) or sleep (S3) state after a change to the system settings. Placing the system in one of these states will result in a power cycle to the processor, which enables the processor to restart with the new system settings in place. A further embodiment may utilize a wake-up timer in order to bring the device out of the selected sleep state. If an embodiment utilizes hibernation (S4) it may result in a system reset on the order of twenty (20) to forty-five (45) seconds depending on the type of memory in use and the information/data that is being backed up and restored. Alternatively, an embodiment that utilizes sleep state S3 could result in a system reset on the order of five (5) to ten (10) seconds.

However, a problem may be created when a wake up timer is set too short. If a wake up timer is set for too short of a period, the computer system may never wake up. This problem can occur because the system has not completed the act of going into sleep mode prior to receiving the wake-up command, and thus did not process the wake up request as it typically would. However, simply setting the wake up timer for a long period of time means a loss of time and productivity. As stated herein, device manufactures have some control over how the sleep states affect the hardware components of a computer system. Thus, one embodiment may utilize a hardware configuration (e.g., specialized wake up circuit) where various hardware components (e.g., hard drive, graphical processing unit, memory, etc.) are not powered down. In a further embodiment, the specialized wake up circuit may send a wake up signal almost instantaneously after receiving the command to enter a sleep state, thus greatly reducing the system down time. This will increase the speed of the sleep process and allow for a shorter wake up timer to be used.

The various embodiments described herein thus represent a technical improvement to a computer system, by reducing the time and actions taken to modify a system setting via the process discussed herein. Specifically, receiving a command to modify a computer system setting; modifying that setting; placing the computer system in a sleep state that removes power from the processor of the computer system; and waking up the computer system using a wake up timer. This is a clear and vast improvement over the current method of a user rebooting a system, which requires the saving of files, closing of applications, waiting for the system to power down/up, entering credentials, and re-initializing the previously active applications.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving a command to modify a setting of a computer system, wherein the modification requires a power cycle to a processor;
modifying, using a processor, the setting of the computer system based on the command;
thereafter, placing the computer system in a sleeping state, wherein the sleep state removes power from the processor; and
automatically waking up the computer system based on a wake up signal.

2. The method of claim 1, wherein the wake up signal is received from at least one of: a wake-up timer and a restart circuit.

3. The method of claim 1, wherein the command comprises a command to change a basic input/output system (BIOS) of the computer system.

4. The method of claim 1, wherein said modifying the setting of the computer system comprises enabling hyper-threading.

5. The method of claim 1, wherein said modifying the setting of the computer system comprises disabling hyper-threading.

6. The method of claim 1, wherein the sleep state comprises system power state S3.

7. The method of claim 1, wherein the sleep state comprises system power state S4.

8. The method of claim 1, wherein said modifying is performed using advanced configuration and power interface (ACPI).

9. The method of claim 1, wherein said modifying is performed using windows management instrumentation (WMI).

10. The method of claim 1, wherein the computer system comprises an operating system that supports hot plugging of components.

11. An information handling device, comprising:
a processor;
a memory device that stores instructions executable by the processor to:
receive a command to modify a setting of a computer system, wherein the modification requires a power cycle to a processor;
modify, using the processor, the setting of the computer system based on the command;
thereafter, place the computer system in a sleeping state, wherein the sleep state removes power from the processor; and
automatically wake up the computer system based on a wake up signal.

12. The information handling device of claim 11, wherein the wake up signal is received from at least one of: a wake-up timer and a restart circuit.

13. The information handling device of claim 11, wherein the command comprises a command to change a basic input/output system (BIOS) of the computer system.

14. The information handling device of claim 11, wherein said modification of the setting of the computer system comprises at least one of: enabling hyper-threading and disabling hyper-threading.

15. The information handling device of claim 11, wherein the sleep state comprises system power state S3.

16. The information handling device of claim 11, wherein the sleep state comprises system power state S4.

17. The information handling device of claim 11, wherein said modification is performed using advanced configuration and power interface (ACPI).

18. The information handling device of claim 11, wherein said modification is performed using windows management instrumentation (WMI).

19. The information handling device of claim 11, wherein the operating system comprises a computer system that supports hot plugging of components.

20. A product, comprising:
a storage device having code stored therewith, the code being executable by a processor and comprising:
code that receives a command to modify a setting of a computer system, wherein the modification requires a power cycle to a processor;
code that modifies, using the processor, the setting of the computer system based on the command;
code that thereafter, places the computer system in a sleeping state, wherein the sleep state removes power from the processor; and
code that automatically wakes up the computer system based on a wake up timer.
